(19) United States
(12) Patent Application Publication
(10) Pub. No.: US 2025/0181062 A1
(43) Pub. Date: Jun. 5, 2025

(54) COMPUTER-SUPPORTED MANUFACTURING METHOD, MANUFACTURING SYSTEM, COMPUTER PROGRAM AND COMPUTER-READABLE MEDIUM

(71) Applicant: TRUMPF WERKZEUGMASCHINEN SE + CO. KG, Ditzingen (DE)

(72) Inventor: Stefan Kerscher, Walzbachtal (DE)

(21) Appl. No.: 19/052,319

(22) Filed: Feb. 13, 2025

Related U.S. Application Data
(63) Continuation of application No. PCT/EP2023/071679, filed on Aug. 4, 2023.

(30) Foreign Application Priority Data
Aug. 18, 2022 (DE) 10 2022 120 898.2

(51) Int. Cl. G05B 19/418

(52) U.S. Cl. CPC G05B 19/4189; G05B 2219/42152

(57) ABSTRACT

A computer-supported manufacturing method for manufacturing at least one workpiece according to a manufacturing order using a processing device and for removing the workpiece from the processing device using a removal device having multiple suction elements is provided. The method includes determining a suction element status for the multiple suction elements, determining suction elements among the multiple suction elements that are capable of being used to remove the workpiece based on a workpiece geometry of the workpiece to be removed, predicting a chance of removal success for the workpiece according to the suction element status of the suction elements that are capable of being used for removal, and carrying out the manufacturing order by the processing device upon predicting a successful removal of the workpiece by the removal device.

### CROSS REFERENCE TO RELATED APPLICATIONS

This application is a continuation of International Application No. PCT/EP2023/071679 (WO 2024/037892 A1), filed on Aug. 4, 2023, and claims benefit to German Patent Application No. DE 10 2022 120 898.2, filed on Aug. 18, 2022. The aforementioned applications are hereby incorporated by reference herein.

### FIELD

Embodiments of the invention relate to a computer-supported manufacturing method for manufacturing a workpiece using a processing device and for removing the finished workpiece from the processing device using a removal device having multiple suction elements. Embodiments of the invention also relate to a manufacturing system, a computer program and a computer-readable medium.

### BACKGROUND

In the case of automated sheet metal processing machines in particular, removal devices are used which remove finished workpieces from a removal area of the sheet metal processing machine and place them in a designated storage area of the removal device, for example a pallet. This makes it possible to achieve a high degree of autonomy in the sheet metal processing machine and to operate it with fewer personnel.

Corresponding removal devices typically have vacuum suction elements that are designed to pick up a workpiece to be removed. If the vacuum suction elements are damaged and/or worn, it may be impossible to remove the workpieces, which can lead to a machine downtime or production downtime.

A method for operating a suction gripper having an electronic control device for a suction frame having multiple suction elements is known from DE 10 2010 040 686 B3, wherein the control device checks whether the suction frame is suitable for processing removal orders on the basis of its actual state. The state includes the number and position of the suction elements as well as their degree of wear and performance characteristics. Furthermore, a match between the suction gripper arrangement and the geometry of the part to be removed can be taken into account. The control device of the suction grippers issues an error message or rejects the removal order as soon as the suction frame reaches a state that is not suitable for processing.

However, the method known from the prior art only prevents incorrect removal of the part that has already been manufactured. In order to still be able to remove manufactured parts, an additional removal device or operator must be provided, which thus increases manufacturing costs. If the pending removal order cannot be carried out by another removal device or an operator, a manufacturing downtime occurs as a result of an unsorted removal area of the processing device. In addition, the degree of autonomy of the manufacturing method decreases, which means that manufacturing can be carried out in a less automatic manner.

### SUMMARY

Embodiments of the present invention provide a computer-supported manufacturing method for manufacturing at least one workpiece according to a manufacturing order using a processing device and for removing the workpiece from the processing device using a removal device having multiple suction elements. The method includes determining a suction element status for the multiple suction elements, determining suction elements among the multiple suction elements that are capable of being used to remove the workpiece based on a workpiece geometry of the workpiece to be removed, predicting a chance of removal success for the workpiece according to the suction element status of the suction elements that are capable of being used for removal, and carrying out the manufacturing order by the processing device upon predicting a successful removal of the workpiece by the removal device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a manufacturing system having a processing device, a removal device and a manufacturing controller, according to some embodiments;

FIG. 2 shows a schematic representation of a computer-supported manufacturing method for manufacturing a workpiece according to a manufacturing plan, according to some embodiments;

FIG. 3 shows a suction element test diagram after determining the suction element status of multiple suction elements, according to some embodiments;

FIG. 4 shows a workpiece with an L-shaped workpiece contour and multiple required suction points, according to some embodiments;

FIG. 5 shows a further workpiece with an I-shaped workpiece contour, having different suction point arrangements, according to some embodiments;

FIG. 6 graphically shows a prediction of the chances of removal for the workpieces from FIGS. 5 and 6, according to some embodiments; and

FIG. 7 graphically shows a further prediction of the chances of removal for the workpiece from FIG. 4, according to some embodiments.

### DETAILED DESCRIPTION

Embodiments of the invention provide a method for operating a processing device with which high manufacturing costs due to redundant removal means and costly delays can be reduced while maintaining a high degree of autonomy. Embodiments of the invention also provide a corresponding manufacturing system, a computer program and a computer-readable medium.

According to embodiments of the invention, a computer-supported manufacturing method is provided. The manufacturing method is suitable for manufacturing at least one workpiece according to a manufacturing order using a processing device.

The manufacturing method is also suitable for removing the finished workpiece from the processing device using a removal device. The removal device has multiple, in particular a large number of, suction elements. With an increasing number of suction elements, the manufacturing method can be carried out particularly effectively.

The manufacturing method comprises at least the following steps:
determining a suction element status for multiple suction elements, in particular each suction element;
determining suction elements that can be used to remove the workpiece on the basis of a provided workpiece geometry of the workpiece to be removed;
predicting a chance of removal success for the workpiece according to the suction element status of the suction elements that can be used for removal.

According to embodiments of the invention, the manufacturing order is executed by the processing device if a successful removal of the finished workpiece can be carried out by the removal device.

In other words, the method according to embodiments of the invention provides for the manufacturing of workpieces using the processing device only if subsequent removal by the removal device can be ensured. This can prevent possible manufacturing downtimes caused by workpieces that cannot be removed, for example, which block the removal area of the processing device. This is particularly advantageous during unmanned shifts, where intervention by an operator is difficult or even impossible.

The manufacturing method provides that a manufacturing order is transmitted to the processing device. The manufacturing order is typically provided to the processing device in a digital format that is readable by the processing device. The manufacturing order contains the manufacturing information necessary to manufacture the workpiece. Manufacturing information can take the form of workpiece parameters, for example a workpiece geometry, a position specification and/or a workpiece contour and/or take the form of processing parameters, for example a feed rate and/or a laser power. This should not be understood as an exhaustive list.

Before the manufacturing order is carried out or accepted by the processing device, the suction element status of multiple suction elements, in particular of each suction element, of the removal device is determined. For example, a suction element status can be determined by measuring the vacuum generated and/or by measuring wear on the suction element sealing lip that comes into contact with the workpiece.

The suction element status of each suction element is typically noted, in particular stored electronically. Preferably, the suction element status is incorporated into further suction element information. Suction element information may, for example, include performance characteristics, in particular a holding force, of the suction element and/or positional information of the suction element. The suction information can be provided by the removal device.

The method according to embodiments of the invention also provides that the workpiece geometry is used to determine the suction elements that can be used. In other words, the workpiece geometry of the workpiece to be manufactured is compared with the available suction elements of the removal device. For example, the available suction elements that can be arranged within the workpiece geometry of the workpiece to be removed can be determined as usable suction elements. This can be achieved, for example, by geometrically comparing the suction element positions with the workpiece geometry of the workpiece to be removed.

According to embodiments of the invention, it is then provided to predict a chance of removal success for the workpiece depending on the suction element status of the suction elements that can be used for removal. In other words, the chance of removal success can be predicted by checking whether the suction element status of the available suction elements is sufficient to successfully remove the workpiece. For example, the status-dependent holding force of the suction elements that can be used can be accumulated, wherein the accumulated holding force must be sufficient to lift the workpiece against the weight of the workpiece.

If a successful removal of the workpiece by the removal device is predicted, the manufacturing order is scheduled to be carried out by the processing device. In other words, the workpiece to be manufactured according to the manufacturing order is only manufactured after confirmation of subsequent successful removal by the removal device. In cases where removal of the finished workpiece by the removal device is predicted to be impossible, it can be provided, for example, that the manufacturing order is rejected by the processing device. In these cases, the processing device is available for manufacturing workpieces according to other manufacturing orders, which can be successfully removed by the removal device.

In a preferred embodiment of the computer-supported manufacturing method, the chance of removal success is predicted by analyzing the workpiece geometry of the workpiece to be removed. By analyzing the workpiece geometry, advantageous workpiece information for removing the workpiece can be determined that cannot be directly obtained from the workpiece geometry. In particular, an uneven distribution of material can be determined, which can lead to tilting moments on the suction elements during removal, for example. A tilting moment can, for example, lead to the workpiece being peeled off the suction elements, which can lead to the removal by the removal device failing. In addition, an analysis of the workpiece geometry can be used to determine a recess and/or an uneven surface on the workpiece. Recesses and/or uneven surfaces can prove difficult or impossible to grasp with a suction element, which means that a suction element cannot be used during removal even if it is in optimal condition. An incorrect or unsuccessful removal can be prevented in this way.

In a further preferred embodiment of the computer-supported manufacturing method, the workpiece geometry is provided with the manufacturing order. This makes the method particularly quick and easy.

In a preferred embodiment of the computer-supported manufacturing method, the chance of removal success is predicted depending on workpiece characteristics, for example the weight, the material, the surface quality and/or the center of gravity of the workpiece to be removed. This makes it possible to predict the performance of a suction element when removing the workpiece and thus the chance of removal even more accurately.

In a further preferred embodiment of the computer-supported manufacturing method, a minimum number of suction points required for removing the workpiece is determined. In other words, the suction points on the workpiece that are required at least for the successful removal of the workpiece can be determined. A successful removal can be predicted if a corresponding minimum number of suction elements with sufficient suction element status can be assigned. In other words, at least one suction element is assigned to each required suction point. Preferably, required performance characteristics, such as a holding force which an assigned suction element must have, are determined at a required suction point. This means that an inadequate suction element status of a suction element can be disregarded when removing the workpiece if the suction element exceeds the minimum number of suction elements required. This can improve the chance of removal even further.

In a preferred embodiment of the computer-supported manufacturing method, at least one suction point arrangement of suction points required for removing the workpiece distributed over the workpiece geometry is determined. A successful removal can be predicted if suction elements with sufficient suction element status can be assigned to the suction points of a suction element arrangement. In other words, it must be possible for the removal device to assign a suction arrangement corresponding to the determined suction point arrangement. In addition, it can be provided that multiple, in particular a large number of, suction point arrangements are determined. This allows the workpiece to be removed using various combinations of suction elements in suction element arrangements, which can increase removal flexibility.

In an additional preferred embodiment of the computer-supported manufacturing method, multiple workpieces are manufactured according to the manufacturing order. In other words, a manufacturing order involves the manufacturing of multiple, in particular a large number of, workpieces. The manufacturing order can be carried out by the processing machine if the removal of each workpiece to be manufactured can be carried out by the removal device. In other words, the chance of removal is determined for each workpiece to be manufactured. This can further reduce manufacturing downtimes.

In a preferred embodiment of the computer-supported manufacturing method, the manufacturing order is provided from an order pool having multiple manufacturing orders. The order backlog preferably comprises multiple, in particular a large number of, manufacturing orders. The manufacturing order can be automatically selected from the order pool depending on the workpieces that can be removed by the removal device. This allows the provision of manufacturing orders to be adapted to the removal options of the removal device.

A further preferred embodiment of the computer-supported manufacturing method has at least two processing devices and at least two removal devices, wherein a manufacturing order that cannot be carried out by the first processing device is assigned to the second processing device. In this regard, a removal of the workpieces to be manufactured by the first removal device can be predicted to be impracticable, whereas removal of the workpieces to be manufactured by the second removal device is possible. In this case, the manufacturing order can be redistributed to ensure that the workpieces are manufactured as quickly and in as timely a manner as possible.

In a further preferred embodiment of the machine management method, the successful removal is predicted using a self-learning algorithm, in particular a neural network. This makes it possible to include a plurality of influencing variables on the chance of removal to be determined in advance, which makes the prediction even more precise.

In addition to the influencing variables already mentioned, such as the suction element status and the workpiece geometry, the chance of removal can be influenced, for example, by a suction element position, a suction element arrangement, a suction point arrangement, a number of suction points, a workpiece material to be used, a workpiece thickness, a workpiece geometry, a number of workpieces to be removed, a number of different workpiece geometries to be removed, a material and/or workpiece surface, a general machine state of the processing device and/or the removal device and/or a position of the workpiece in the removal area. In addition, the inclusion of other influencing variables that affect the chance of removal of the workpiece can be provided.

The self-learning algorithm is preferably trained using a plurality of determined influencing variables whose effect on a predetermined chance of removal is known. Typically, the determined influencing variables are available as a data link for each respective manufacturing order, the removal result of which is known. The influencing variables can be provided manually by an operator or automatically by the machine. For example, it can be provided that one or more influencing variables are determined during the processing or performance of a manufacturing order and are recorded or stored in a data network. The removal result of the manufacturing order—or the successful or unsuccessful removal by the removal device—can be assigned to the data network. The removal result can be determined manually by an operator and/or automatically by the removal device. For example, it can be provided that if the removal device aborts the removal, a negative removal result is automatically added to the data network and/or if the removal is successful, a positive removal result is automatically added to the data network. Furthermore, for example, it can be provided that the operator determines the successful removal by the removal device and manually assigns the removal result to the corresponding data network.

Preferably, the influencing variables are collected for a plurality of manufacturing orders to improve the accuracy of the prediction. The influencing variables are preferably transferred from a plurality of machines and/or operators by means of known data transmission to a central data storage device, which serves as the basis of the self-learning algorithm.

The underlying object is further achieved by a manufacturing system comprising a manufacturing controller configured to perform the method described above.

The manufacturing system has at least one processing device and at least one removal device. The at least one processing device is preferably designed as a sheet metal processing device, in particular a laser cutting machine. The removal device is preferably designed as a suction gripper device having multiple suction elements.

The manufacturing controller can be configured to distribute manufacturing orders. The manufacturing controller can be integrated into a controller of the processing device and/or the removal device. Preferably, the manufacturing controller is designed as a separate component of the manufacturing system, whereby the manufacturing method can be extended particularly easily to further processing and removal devices.

The suction elements can be arranged individually and/or in a suction element assembly, for example in a suction frame. The removal device can have multiple suction elements. The suction elements and/or suction element combinations can be used individually or together to remove a workpiece. The suction elements can be movable individually and/or in combination, in particular relative to one another.

In addition, the underlying object is achieved by a computer program on a data carrier for carrying out the method described above.

Furthermore, the underlying object is achieved by a computer-readable medium which comprises the previously described computer program for carrying out the previously described method.

According to embodiments of the invention, the features mentioned above and those yet to be explained further may be used in each case individually or together in any desired expedient combinations. The embodiments shown and described should not be understood as an exhaustive list, but rather are of an exemplary character.

FIG. 1 shows a schematic representation of a manufacturing system 10 having a processing device 12—for example in the form of a laser cutting machine—a removal device 14, a prediction unit 16 and a manufacturing controller 18. The manufacturing controller 18 is configured to communicate with the processing device 12 and the removal device 14. The manufacturing system 10 may have multiple processing devices 12 and/or multiple removal devices 14, which preferably all communicate with the manufacturing controller 18.

The manufacturing controller 18 is typically designed to organize manufacturing orders 20. A manufacturing order 20 typically contains manufacturing information on one or more workpieces to be manufactured 22. Manufacturing information can, for example, be information about a workpiece geometry (such as a contour to be manufactured), the workpiece position and/or the manufacturing quality. The manufacturing controller 18 can be designed as part of the processing device 12 and/or the removal device 14 and/or as an independent component as shown.

The processing device 12 is designed to manufacture workpieces 22 according to a manufacturing order 20. For this purpose, the manufacturing controller 18 can transmit one or more manufacturing orders 20 to the processing device 12. For example, it can be provided that a laser cutting machine receives a manufacturing order 20 for cutting out a workpiece 22 from a flat raw material.

The at least one finished workpiece 22 is usually removed by the preferably automated removal device 14 from a removal area 24 of the processing device 12 and placed in a corresponding storage area (not shown in detail) for further processing.

For this purpose, the removal device 14 has multiple suction elements 26. The suction elements 26 are designed in conjunction with the workpiece 22 to be removed to generate a negative pressure at a contact point with the workpiece 22, which causes the workpiece 22 to adhere to one or more suction elements 26. While the workpiece 22 is held on the one or more suction elements 26, it follows a suction element movement and can thus be transported into the storage area. To place the workpiece 22, the negative pressure generated at the contact point is released and the connection between the workpiece 22 and the one or more suction elements 26 is released.

The removal device 14 comprises measuring means (not shown in detail) for determining the suction element status of multiple, in particular of all, suction elements 26. The suction element status can then be transmitted as an influencing variable 28 to the prediction unit 16, which stores the influencing variable 28 related to the suction element statuses. In addition to the suction element statuses, the influencing variable 28 can have further suction element information, in particular the position and/or the holding force of each suction element 26. In addition, the prediction unit 16 is designed to store the workpiece geometry of the workpiece 22 to be manufactured in the form of an influencing variable 30. The workpiece geometry can be provided to the prediction unit 16 manually. Preferably, the workpiece geometry is transmitted automatically by the manufacturing controller 18, the processing device 12 and/or the removal device 14.

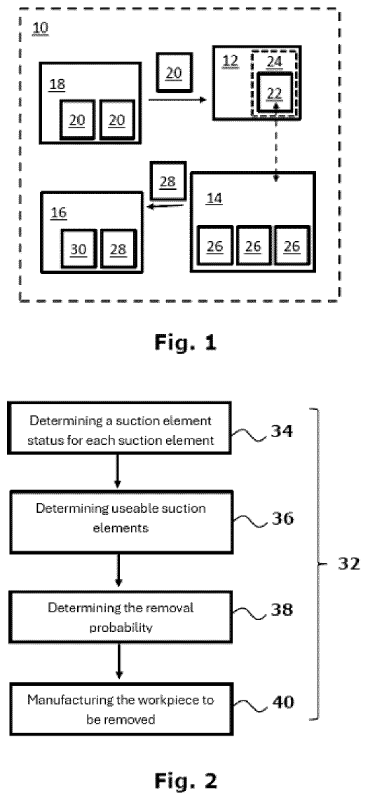

FIG. 2 shows a schematic representation of the manufacturing method 32 according to embodiments of the invention. For a better explanation, reference is made to the components of the manufacturing system 10 shown in FIG. 1.

In a first method step 34, the suction element status of multiple suction elements 26 of the removal device 14 is determined. The suction element statuses are then noted, preferably stored, in the prediction unit 16.

In a further method step 36 the suction elements 26 of the removal device 14 that can be used to remove the workpiece 22 to be manufactured are determined. For this purpose, the provided workpiece geometry of the workpiece 22 to be manufactured is used as a basis. For example, those suction elements 26 of the removal device 14 can be determined as usable suction elements 26 which are movable over the workpiece geometry for arrangement on the workpiece 22 to be removed.

In a further method step 38, the chance of removal of the workpiece 22 to be removed is predicted by means of the usable suction elements 26. For example, a prediction of the chance of removal can be based on the fact that in order to lift the workpiece 22 to be removed, the cumulative holding force of the suction elements 26 that can be used for removal, which depends on the suction element status, exceeds the opposing weight force of the workpiece 22.

If the successful removal of the workpiece 22 is predicted or predetermined, according to a further method step 40 the workpiece 22 to be manufactured is manufactured by the processing device 12. In other words, the manufacturing order 20 directed to the processing device 12 is carried out by the processing device 12.

In the event that the workpiece 22 to be manufactured cannot be removed by the removal device 14, it is provided that the workpiece 22 to be manufactured is not manufactured by the processing device 12. In other words, the manufacturing order 20 is rejected by the processing device 12. This can prevent a manufacturing downtime resulting from the blockage of the removal area 24 of the processing device 12 as a result of incorrect and/or impracticable removal of the finished workpiece 22.

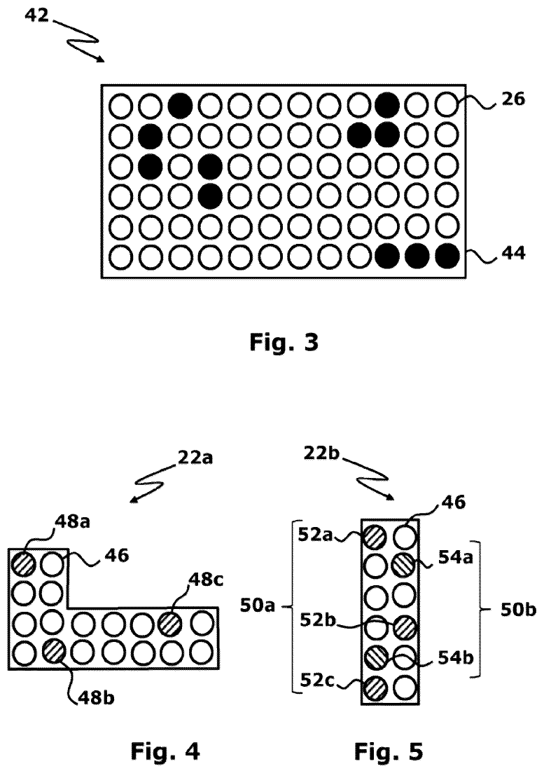

FIG. 3 shows a schematic representation of a suction test diagram 42 of the removal device 14 with a plurality of suction elements 26 (for reasons of clarity, only one suction element 26 is provided with a reference symbol). The suction element test diagram 42 can be understood as a graphical representation of the suction element status determination. The arrangement of the suction elements 26 according to the suction element test diagram 42 can correspond to the actual arrangement of the suction elements 26 on the removal device 12. The suction elements 26 can have fixed coordinates which enable a determination of the suction element position on the removal device 14 or a positioning above the workpiece 22 to be removed (see FIG. 1).

As shown, the determination of the suction element status by suitable test equipment may show that the removal device 14 has one or more defective suction elements 44 (shown here in black). Defective suction elements 44 may, for example, only have a reduced holding force, which may result, for example, from a leak in the suction element or a valve defect.

FIG. 4 and FIG. 5 each show a schematic representation of a possible workpiece to be manufactured 22a, 22b.

The workpieces 22a and 22b differ from each other in their workpiece geometry. For example, the workpiece 22a has an L-shaped workpiece contour, while the workpiece 22b has a rectangular workpiece contour.

Both the workpiece 22a and the workpiece 22b each have multiple suction points 46. According to the example shown, the workpiece 22a has eighteen suction points 46 and the workpiece 22b has twelve suction points 46.

An analysis of the workpiece geometry 22a can, for example, show that not all suction points 46 are required to lift the workpiece 22a. The required suction points 48a-c can be significantly smaller in number, as shown (hatched). In the example shown, the workpiece 22a has three required suction points 48a-c. The number of required suction points 48a-c may depend on the position of the required suction points 48a.

The workpiece 22b has a first suction point arrangement 50a with three required suction points 52a-c. The analysis of the workpiece geometry can provide a second suction point arrangement 50b with required suction points 54a, b. The second suction point arrangement 50b can have a smaller number of required suction points 54a, b due to the arrangement of the required suction points 54a, b.

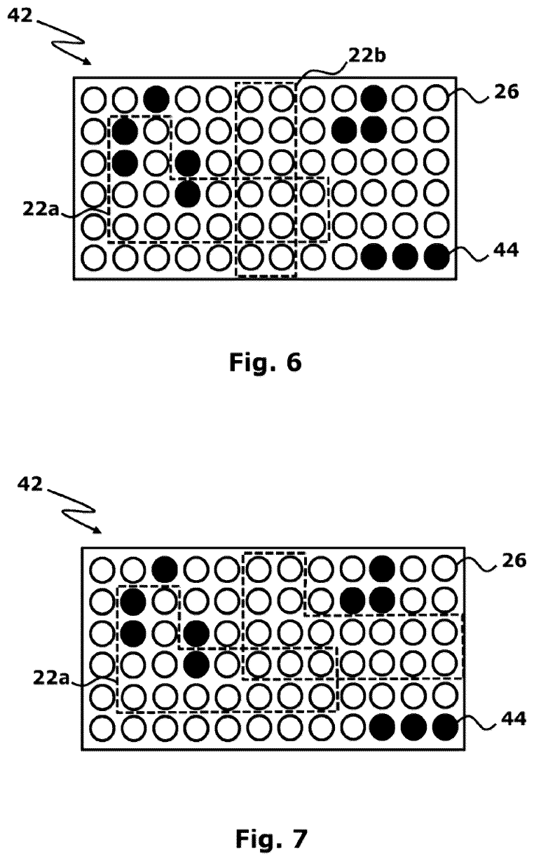

FIG. 6 graphically illustrates the prediction of the chance of removal success of the workpieces 22a, 22b depending on the suction element statuses on the suction element test diagram 42.

The workpieces 22a, 22b can be transmitted to the processing device 12 for manufacturing in a common or in two separate manufacturing orders 20. The manufacturing orders 20 can have workpiece positions and/or predetermined suction element positions for removing the workpieces 22a, b.

As shown, the suction elements 26 that can be used for removal can be determined depending on the workpiece geometry. The suction elements 26 that can be used can, for example, be the suction elements 26 of the removal device 14 (see FIG. 1) that can be arranged on the workpiece geometry. In the example shown, multiple defective suction elements 44 are located within the workpiece geometry of the workpiece 22a. Due to the reduced holding force of the defective suction elements 44, the cumulative holding force for lifting the workpiece 22 may be insufficient. In this case, the chance of removal of the workpiece 22a can be predicted to be low. As a result of the low chance of removal, it can be provided that the manufacturing order 20 for the workpiece 22a is rejected by the processing device 12. This can prevent a manufacturing downtime as a result of a failed removal.

As shown, the suction element test diagram 42 shows only intact suction elements 26 within the workpiece geometry 22b. The chance of removal for the workpiece 22b can be predicted to be high. As a result of the high expected chance of removal success, it can be provided that the manufacturing order 20 for the workpiece 22b is carried out by the processing device 12.

FIG. 7 illustrates a further development of the prediction method for the workpiece 22a from FIG. 6. The further development can provide an increase in the chance of removal by removing the workpiece 22a from the removal device 12 by means of other suction elements 26. In other words, the predetermined relative removal position of the removal device 12 to the workpiece 22a is changed so that intact suction elements 26 can be arranged on the workpiece geometry. In other words, defective suction elements 44 are bypassed during removal. This can increase the cumulative holding force, enabling successful removal. In the case shown, it can be provided that the manufacturing order 20 for manufacturing the workpiece 22a is carried out by the processing device 12.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

Manufacturing system 10;
Processing device 12;
Removal device 14;
Prediction unit 16;
Manufacturing controller 18;
Manufacturing order 20;
Workpiece 22;
Removal area 24;
Suction element 26;
Influencing variable 28;
Influencing variable 30;
Manufacturing method 32;
Method step 34;
Method step 36;
Method step 38;
Method step 40;
Suction element frame 42;
Defective suction element 44;
Suction point 46;
Required suction point 48a-c of the first workpiece 22a;
First suction point arrangement 50a of the workpiece 22b;
Required suction point 52a-c of the first suction point arrangement 50a;
Second suction point arrangement 50b of the workpiece 22b;
Required suction point 54a, b of the second suction point arrangement 50b.

1. A computer-supported manufacturing method for manufacturing at least one workpiece according to a manufacturing order using a processing device and for removing the workpiece from the processing device using a removal device having multiple suction elements, the method comprising:
determining a suction element status for the multiple suction elements;
determining suction elements among the multiple suction elements that are capable of being used to remove the workpiece based on a workpiece geometry of the workpiece to be removed;
predicting a chance of removal success for the workpiece according to the suction element status of the suction elements that are capable of being used for removal; and
carrying out the manufacturing order by the processing device upon predicting a successful removal of the workpiece by the removal device.

2. The computer-supported manufacturing method according to claim 1, wherein the chance of removal success is predicted by analyzing the workpiece geometry of the workpiece to be removed.

3. The computer-supported manufacturing method according to claim 1, wherein the workpiece geometry is provided with the manufacturing order.

4. The computer-supported manufacturing method according to claim 1, wherein the chance of removal success is predicted depending on workpiece characteristics of the workpiece to be removed.

5. The computer-supported manufacturing method according to claim 1, further comprising determining a minimum number of suction points required for removing the workpiece, wherein the successful removal of the workpiece is predicted when a number of suction elements with sufficient suction element status correspond to the minimum number of suction points.

6. The computer-supported manufacturing method according to claim 1, further comprising determining at least one suction point arrangement of suction points required for removing the workpiece distributed over the workpiece geometry, wherein the successful removal is predicted when the suction elements with sufficient suction element status are capable of being assigned to the suction points.

7. The computer-supported manufacturing method according to claim 1, wherein multiple workpieces are manufactured according to the manufacturing order, and wherein the manufacturing order is carried out by the processing machine upon predicting the successful removal of each workpiece to be manufactured by the removal device.

8. The computer-supported manufacturing method according to claim 7, wherein the manufacturing order is provided from an order pool having multiple manufacturing orders, and wherein the manufacturing order is automatically selected from the order pool depending on the workpieces that are capable of being removed by the removal device.

9. The computer-supported manufacturing method according to claim 1, wherein at least two processing devices and at least two removal devices are used, wherein the manufacturing order that is not capable of being carried out by a first processing device is assigned to a second processing device.

10. The computer-supported manufacturing method according to claim 1, wherein the successful removal is predicted using a self-learning algorithm.

11. A manufacturing system comprising a manufacturing controller configured to perform the manufacturing method according to claim 1.

12. A non-transitory computer-readable medium comprising a computer program stored thereon, the computer program, when executed by a computer processor, causing performance of the manufacturing method according to claim 1.
